(19) United States
(12) Patent Application Publication
(10) Pub. No.: US 2008/0076056 A1
(43) Pub. Date: Mar. 27, 2008

(54) METHOD TO PREPARE TONER COMPOSITION

(75) Inventors: In Kim, Suwon-si (KR); Sang-deok Kim, Gwangmyeong-si (KR); Kyung-yol Yon, Seongnam-si (KR); Duck Hee Lee, Seoul (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/684,059

(22) Filed: Mar. 9, 2007

(30) Foreign Application Priority Data
Sep. 27, 2006 (KR) 10-2006-094400

(51) Int. Cl. G03C 1/795

(52) U.S. Cl. 430/137.15

(57) ABSTRACT

A method to prepare a toner composition using a continuous reactor may include inputting a first monomer, a second monomer, and a polymerization initiator into the continuous reactor to polymerize the first and second monomers, and adding a releasing agent, a colorant, and a charge control agent to the polymer of the first and second monomers.

### CROSS-REFERENCE TO RELATED APPLICATIONS

This application claims priority under 35 U.S.C. § 119(a) from Korean Patent Application No. 10-2006-094400, filed Sep. 27, 2006, in the Korean Intellectual Property Office, the entire disclosure of which is hereby incorporated by reference.

### BACKGROUND OF THE INVENTION

1. Field of the Invention

The present general inventive concept relates to a method to prepare a toner composition, more specifically, to a method to prepare a toner composition in a continuous stream.

2. Description of the Related Art

A toner is a recording material used to form an image onto a recording medium. For example, a black toner to form a black/white image, and a color toner of a large variety of colors to form a color image.

Numerous preparation methods are known for the preparation of a conventional toner composition. In one of the most common methods, a binder resin, colorants, wax, and the like are mixed together, and then are melt kneaded or extruded. The melt-kneaded or extruded toner composition is then micronized or pulverized, and classified according to toner particle size. Then, external additives are added to the toner particles to improve a flowability, a charge stability, and so on.

Such a toner may be classified into pulverized toner and polymerized toner according to the preparation method.

In case of the pulverized toner, a binder resin is used as a polymer in a macromolecule form. In preparing the pulverized toner, a binder resin in a macromolecule form, a releasing agent, a colorant, a charge control agent, and the like are preliminary mixed in a given mixer. This preliminary mixed compound is further mixed and melted in an extruder to continuously produce a composition containing toner particles. The toner composition is then subjected to a classification process to obtain toner particles of a desired particle size. After classification, the composition is mixed with, for example, large silica particles for improving transferability, filming, and endurance, small silica particles for improving feedability through provision of flowability and for enhancing the amount of charge, metal oxide for improving environmental properties and for stabilizing the charge properties, and external additives for improving the charge properties to produce a final toner component.

On the other hand, in the case of the polymerized toner, a binder toner is used not as a polymer in a macromolecule form, but as a monomer, and the polymerization is incorporated with the addition of internal additives. In general, methods such as a suspension polymerization method and an emulsion-aggregation polymerization method are known as the preparation methods for polymerized toner. In the case of the suspension polymerization, a monomer, a colorant, and a releasing agent are mixed in water as a solvent, dispersed mechanically with help of a stirrer, and heated to the proper temperature to be polymerized. Moreover, a stabilizer is added to stably maintain the internal additives, including the colorant, the releasing agent, and the like in the particles. Later, remaining monomers are removed, followed by addition of external additives same as in the preparation of pulverized toner.

In the case of emulsion polymerization, a latex of emulsified polymer, a releasing agent, a colorant, a charge control agent, and the like are emulsified, and a particle size is controlled through temperature adjustment. Then, the particles are stabilized and aggregated by heating. Finally, the addition of external additives, same as in the preparation of pulverized toner, is performed.

In case of the preparation of pulverized toner, binary blends containing more than two kinds of resins or homopolymers are used. However, when a homopolymer is used singly, it is difficult to meet the required endurance and fixability for developing an electrostatic image.

This is because the relation between endurance and fixability of the toner is more like a trade-off relation, so there is a limit to a control of the physical properties of the toner composition by using a single homopolymer. Therefore, it is customary to use a blend of two kinds of homopolymers. However, the simple blend type composition still poses a problem in terms of compatibility.

Meanwhile, in the case of the preparation of polymerized toner, although the problems found in the pulverized toner are resolved, there are other problems, for example, a treatment of sewage water due to the type of solvents or surfactants used during the process, an elimination of residual substances, disadvantages of a discontinuous process, etc.

Accordingly, there is a need for a new method to prepare a toner that can minimize the disadvantages of the conventional methods but can maximize advantages thereof.

### SUMMARY OF THE INVENTION

The present general inventive concept provides a method to prepare a toner composition in a continuous stream, wherein limitations on physical properties of the toner composition can be overcome, is easy to control a toner composition and a molecular weight of the toner composition, a low temperature fixability and an endurance of the toner composition can be improved, while the toner composition becomes environmentally friendly.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept may be achieved by providing a method to prepare a toner composition using a continuous reactor, the method including inputting a first monomer, a second monomer, and a polymerization initiator into the continuous reactor to polymerize the first and second monomers, and adding a releasing agent, a colorant, and a charge control agent to the polymer of the first and second monomers.

The first monomer and the second monomer can be sequentially inputted into the continuous reactor, and can be polymerized into one of a random copolymer, a block copolymer and a graft copolymer.

The first monomer can be one of a lactam monomer and a lactone monomer and the second monomer can be one of a lactone monomer and a lactam monomer.

The lactam monomer can be selected from a group consisting of ω-lauryl lactam, ε-caprolactam, and mixtures thereof.

The lactone monomer can be selected from a group consisting of ε-caprolactone, butyrolactone, and mixtures thereof.

The polymerization initiator can be an anion polymerization initiator, in particular, sodium hydroxide. In addition, a conductive polymer, polythiophene for example, can be used as a charge control agent.

The continuous reactor may have at least one inlet, and the toner composition can be prepared in the continuous reactor in continuous stream and extruded.

The foregoing and/or other aspects and utilities of the present general inventive concept may also be achieved by providing a method of preparing a toner composition, the method including inputting a first monomer into a reaction chamber, inputting a second monomer into reaction chamber, and inputting a polymerization initiator into the reactor to polymerize the first and second monomers, wherein the first and second monomers are sequentially inputted into the reaction chamber, and the reaction chamber continuously reacts and extrudes the resulting polymer.

The method may further include adding a releasing agent, a colorant, and a charge control agent to the polymer of the first and second monomers.

The sequential input of the first and second monomers may include inputting the first monomer at a first position of the reaction chamber, and inputting the second monomer at a second position, a predetermined distance from the first position downstream with respect to a traveling direction of the resulting polymer.

The sequential input of the first and second monomers may include inputting the first monomer at a first time of the reaction chamber and inputting the second monomer at a second time, a predetermined time after the first monomer is input.

The predetermined distance between the first and second position may be selected to maximize a ratio of block copolymer produced.

The predetermined time between the first time and the second time may be selected to maximize a ratio of block copolymer produced.

The first monomer may be a lactam monomer and the second monomer may be a lactone monomer or vice versa.

The foregoing and/or other aspects and utilities of the present general inventive concept may also be achieved by providing a method of preparing a toner composition, the method including sequentially inputting different monomers into a continuous reaction chamber, inputting a polymerization initiator into the continuous reaction chamber to polymerize the monomers, and adding a releasing agent, a colorant, and a charge control agent to the polymer of the first and second monomers.

The sequential input of the different monomers may include one of inputting a second monomer a predetermined time after a first monomer is input, and inputting a second monomer a predetermined distance from a position of input of a first monomer, with respect to a traveling direction of the resulting polymer, wherein the predetermined time and the predetermined distance are selected to maximize a ratio of block copolymer produced.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 illustrates a continuous reactor usable in a method to prepare a toner composition according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

A method to prepare a toner composition by using a continuous reactor according to an exemplary embodiment of the present general inventive concept may include polymerizing a first monomer and a second monomer in the continuous reactor in the presence of a polymerization initiator, and adding a releasing agent, a colorant, and a charge control agent thereto.

The continuous reactor is a vessel in which a product of a reaction moves in a designated direction in a continuous stream to thereby perform a continuous reaction, and from which the product can be extruded through an outlet formed in one side of the reactor.

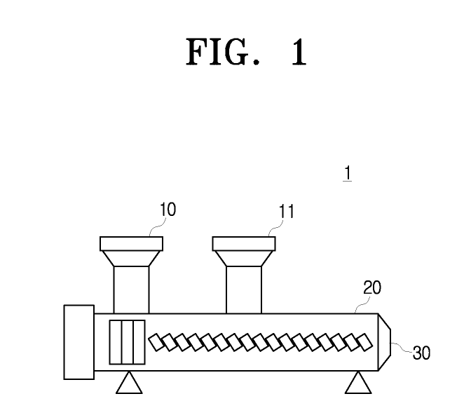

FIG. 1 illustrates an example of a continuous reactor 1 where a method to prepare a toner composition according to the present general inventive concept can be carried out.

The continuous reactor 1 may include a first inlet 10, a second inlet 11, a reaction tub 20, and an outlet 30.

The reactants, i.e., the first and second monomers, the polymerization initiator, the releasing agent, the colorant, and the charge control agent, inflow through the first and second inlets 10 and 11 into the reactor.

According to an embodiment of the present general inventive concept, the first monomer inflows through the first inlet 10 and the second monomer flows through the second inlet 11. In a case where the second monomer is introduced into the reactor through the first inlet 10, the first monomer can be introduced into the reactor through the second inlet 11. That is to say, the different monomers may be introduced through different inlets, respectively. Alternatively, the first and second monomers may be introduced through the same inlet. While FIG. 1 illustrates the continuous reactor 1 with plural inlets, the present general inventive concept is not limited thereto, and a continuous reactor having a single inlet may also be used to realize the method to prepare a toner composition according to the present general inventive concept. Additionally, the continuous reactor may have additional inlet to input other components into the reaction chamber.

The first monomer and the second monomer can be sequentially inputted into the continuous reactor 1. These monomers are polymerized in the reaction tub 20 and extruded through the outlet 30. Compared with a simultaneous input of the first and second monomers, sequentially inputting the first and second monomers enables an easier adjustment of a polymerization start time point and an easier differentiation of an input time of the monomers in consideration with a reaction rate of each monomer, thereby guiding the reaction to promote polymerization.

By adjusting the input times of the monomers, the first and second monomers can be polymerized into one of a random copolymer, a block copolymer, and a graft copolymer.

In a random copolymer, monomeric units are at random sites of a polymer. In a block copolymer, monomeric units repeat at a fixed ratio. In a graft copolymer, a monomer is polymerized and other monomers are polymerized with the polymerized chain in a branch shape.

If the first monomer and the second monomer are simultaneously inputted through one inlet, a ratio of random copolymers in a polymer increases. Meanwhile, if the first and second monomers are sequentially or separately inputted, a ratio of block copolymers in a polymer increases. In a case of a polymer blend where monomers are simply polymerized together, the resultant polymer blend typically has degraded properties compared with properties of each of the monomers. On the other hand, in a case of a random copolymer and a graft copolymer, properties of each monomer are blended to create different properties. In case of a block copolymer, where each monomer is polymerized in block unit, properties of individual monomer are retained.

Therefore, the block copolymer may be more desirable than the other copolymer types because the polymer is produced while keeping desirable properties of every monomer in it. Accordingly, the monomers may be sequentially input to obtain a high block copolymer ration.

Any monomers suitable for the binder resin of a toner may be used as the first and second monomers. Examples of such monomers include, but are not limited to, polyester, styrene, divinyl benzene, n-butyl acrylate, metacrylate, and (meta) acrylic acid. Monomers may be used singly or in combination.

However, polyester- and styrene-acryl based monomers are often blamed for a production of environmentally harmful substances, for example, catalysts used in the polymerization (tin group, heavy metals, e.g., Co, Ni, and VI) or volatile organic compounds produced from non-reacted monomers.

Therefore, the first and second monomers may be aliphatic polyester. For example, the monomers used in the present general inventive concept may be lactam monomers or lactone monomers. Here, examples of the lactam monomers include ω-lauryl lactam, ε-caprolactam, and mixtures thereof. Examples of the lactone monomers include ε-caprolactone, butyrolactone, and mixtures thereof.

Among the lactone monomers, ε-caprolactone for example is an aliphatic ester monomer as a crystal polymer with a cyclic structure. This monomer compound is a human eatable/non-toxic, environmentally friendly, and biodegradable substance, and improves a fixability of toner particles.

Among the lactam monomers, ω-lauryl lactam has an aliphatic amide ring structure, and is a most moisture-insensitive and reactive among the amide-based compounds. Thus, it serves to improve an endurance of the toner.

Additionally, a polymerization initiator can be inputted to polymerize the first monomer and the second monomer. For example, an anion based polymerization initiator can be used, such as, sodium hydroxide.

Besides the polymerization initiator, a cocatalyst may be used. The cocatalyst is an element that is added to increase a catalyst activity, or to control/change a reaction caused by a catalyst. For example, N-acetyl caprolactam can be used as a cocatalyst.

As aforementioned, after putting the first monomer, the second monomer, and the polymerization initiator in the continuous reactor 1 to cause the polymerization reaction, a releasing agent, a colorant, and a charge control agent are inputted to the toner particles as internal additives.

Even though the releasing agent, the colorant, and the charge control agent may be introduced through the first inlet 10 and the second inlet 11, they may be inputted only through the second inlet 11 in consideration of the reaction time of the first monomer.

The releasing agent improves a releasability between a roller and a toner when a toner image is transferred onto a recording medium to prevent a toner offset. Many times, the recording medium is adhered to the roller because of the toner, so the recording medium is easily caught in the middle. This is why the releasing agent may be added to the toner composition.

Typically used releasing agents are a polyolefin group having low molecular weight, a silicon group having a softening point by the application of heat, a fatty acid amid group, and wax. Among these, commercially made wax is easy to get.

Examples of wax as a releasing agent of a toner component are natural waxes including waxes from a plant, such as, carnauba wax and bayberry wax, and waxes from an animal, such as, beeswax, shellac wax, and supermaceti wax; mineral waxes, such as, montan wax, ozokerite wax, and ceresin wax; and synthetic waxes, such as, paraffin wax, microcrystalline wax, polyethylene wax, polypropylene wax, acrylate wax, fatty acid amid wax, silicon wax, and polytetrafloroethylene wax. These waxes may be used singly or in mixture of two or more.

The colorant is a substance exhibiting color of toner particles. Colorants are largely divided into dye colorants and pigment colorants. Any widely used commercial colorant can be used as a toner colorant in the present general inventive concept. For example, pigment colorants with excellent thermal stability and lightproofness may be used.

Examples of such pigment colorants for use in the present general inventive concept include, but are not limited to, azo pigments, phthalocyanine pigments, basic dyes, quinacridone pigments, dioxazine pigments, diazo pigments, chromate, ferrocyanices, oxide, selenium sulfide, sulfate, silicate, carbonate, phosphate, metal powder, and carbon black.

The charge control agent is employed to control a quantity of electric charge on toner particles (also called a charge assistant, charge directing agent, and so on). Depending on the charge (positive or negative) of the toner particles, different kinds of charge control agents can be used.

Examples of a negative charge control agent include azo dyes, salicylic acid metal complexes containing a metal like chrome, iron and zinc, and so on. Examples of a positive charge control agent include nigrosine, quaternary ammonium salts, triphenylmethane derivatives, and so on.

A conductive polymer, e.g., polyaniline, polypyrol, and polythiophene, may be used as the charge control agent. For example, liquid polythiophene with an excellent charge control performance can be used to ensure uniform chargeability.

### EXAMPLES

In Example 1, a toner composition is prepared using a continuous reactor according to an embodiment of the present general inventive concept, and in Example 2 a toner composition is prepared with a different content ratio of monomers according to the present general inventive concept. The following examples are aimed to be illustrative of the present general inventive concept. However, they should not be construed as limiting the scope of this general inventive concept.

### Example 1

In preparing the first monomer, 6.340 mol of ω-lauryl lactam, 0.1250 mol of sodium hydroxide, and 0.097 mol of N-acetylcaprolactam were mixed in a dry box, under an inert gas (Ar) atmosphere. Later, the mixture was inputted through the first inlet at a speed of 1.3 kg/hr by using a solid type feeder.

In preparing the second monomer, 2.09 mol of ε-caprolactone, and with respect to a total weight of the two monomers, 2 wt % carnauba wax as a releasing agent, 3 wt % of carbon black as a colorant, and 1 wt % of liquid polythiophene as a charge control agent were inputted through the second inlet. Polythiophene in a liquid phase contains 1.2 to 2.2% of solid, and features a viscosity of 10 to 30 mPa·s, a pH value of 3 to 8, and a density of 0.900 to 0.926 g/cm³. The ε-caprolactone, the releasing agent, the colorant, and the charge control agent were preheated at about 100° C., and were inputted into the reactor using a liquid feeder.

A twin screw extruder was used as the continuous reactor under controlled conditions. In detail, a barrel temperature was set to 195° C., a screw speed was set to 150 rpm, and inflow speeds at the first and second inlets were set to 1.3 kg/hr and 1.5 kg/hr, respectively.

Under the above conditions, a mean residence time in the extruder was approximately 400 sec. The mixture was pulverized in a Bantam-mill pulverizer to produce medium pulverized particles of about 1-2 mm in size, and further pulverized in a Super-rotor to produce super fine pulverized particles of about 15 μm in size. Last, toner particles of less than 5 m in size were classified by centrifugal force to thereby obtain a particle size of about 8.0±0.5 μm.

Next, as external additives, 1.0-1.6% of coarse SiO₂, 0.8-1.3% of fine powder SiO₂, 0.1-0.3% of a metal oxide (TiO₂, Al₂O₃ and the like), and 0.1-0.3% of polymer bead (melamine group, PMMA group) were added and mixed in Henschel mixer at 3500-3800 rpm for 7-10 minutes, and screened.

When thermal analysis was done using a DSC (Differential Scanning Calorimetry), crystalline melting points were 60° C., 80° C., and 170° C., respectively.

Because ε-caprolactone, carnauba wax, and ω-lauryl lactam are all crystalline substances, melting points do not exist when the conventional amorphous polymer resin binder was used, and one can observe a very wide range of fixing properties. However, when the lactam-lactone copolymer was used, as in this example, a very narrow range of fixing properties can be realized during fixing an image. Therefore, the method to prepare a toner composition according to the present general inventive concept can be advantageously used for an engine requiring a very short fixing time, such as, a high-speed image forming device.

### Example 2

Toner particles were obtained in the same manner as in Example 1 except that 6.01 mol of ε-caprolactone was inputted through the second inlet.

### Evaluation

Properties of toner compositions thus prepared in Examples 1 and 2 were evaluated as follows:

### 1) Fixability and Endurance

100 ml of ink compositions prepared according to Examples 1 and 2 were put into a heat-resistance glass bottle, respectively, sealed and kept in a 60° C. constant temperature vessel. Two months later, an existence of sediments on the bottom was checked and an evaluation was made as follows. The results are provided in Table 1 below.

For the fixability test, a solid image was measured by taping, and expressed in percentage. The endurance test was conducted in an H/H environment (32° C./80%) in reference to an image formation damage phenomenon of a solid image in a 16 PPM class image forming device (2% coverage black image, 3.0K print cartridge).

The evaluation results are shown in Table 1.

TABLE 1

| | Fixability | Endurance |
|---|---|---|
| Ex. 1 | 90% | Excellent |
| Ex. 2 | 95% | Excellent |

As described above, by using the continuous reactor, lactone and lactam monomers, and polythiophene in liquid phase as the charge control agent, the resultant toner compositions exhibited a superior fixability and endurance. In addition, as can be seen in the result for Example 2, fixability was improved even more when the content of ε-caprolactone was increased.

As explained above, according to the present general inventive concept, the toner composition can be manufactured in a continuous stream. Also, without degrading physical properties of the toner composition, it is easy to control over the toner composition at the same time. Further, the molecular weight of the toner composition is easily controlled, thereby improving an overall preparation process of the toner composition.

Moreover, the toner composition of the present general inventive concept is more environmentally friendly and features excellent performance as it is made from materials that are environmentally friendly, have enhanced fixability and endurance, and exhibit excellent charge control performances.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method to prepare a toner composition using a continuous reactor, the method comprising:
inputting a first monomer, a second monomer, and a polymerization initiator into the continuous reactor to polymerize the first and second monomers; and
adding a releasing agent, a colorant, and a charge control agent to the polymer of the first and second monomers.

2. The method of claim 1, wherein the first monomer and the second monomer are sequentially inputted into the continuous reactor.

3. The method of claim 1, wherein the first monomer and the second monomer are polymerized into one of a random copolymer, a block copolymer and a graft copolymer.

4. The method of claim 1, wherein the first monomer is one of a lactam monomer and a lactone monomer and the second monomer is one of a lactone monomer and a lactam monomer.

5. The method of claim 4, wherein the lactam monomer is selected from a group consisting of ω-lauryl lactam, ε-caprolactam, and mixtures thereof.

6. The method of claim 4, wherein the lactone monomer is selected from a group consisting of ε-caprolactone, butyrolactone, and mixtures thereof.

7. The method of claim 1, wherein the polymerization initiator is an anion polymerization initiator.

8. The method of claim 7, wherein the polymerization initiator is sodium hydroxide.

9. The method of claim 7, wherein the charge control agent is a conductive polymer.

10. The method of claim 8, wherein the charge control agent is polythiophene.

11. The method of claim 1, wherein the continuous reactor has at least one inlet.

12. The method of claim 1, wherein the toner composition is prepared in the continuous reactor in continuous stream and extruded.

13. A method of preparing a toner composition, the method comprising:
inputting a first monomer into a reaction chamber;
inputting a second monomer into reaction chamber; and
inputting a polymerization initiator into the reactor to polymerize the first and second monomers,
wherein the first and second monomers are sequentially inputted into the reaction chamber, and the reaction chamber continuously reacts and extrudes the resulting polymer.

14. The method of claim 13, further comprising:
adding a releasing agent, a colorant, and a charge control agent to the polymer of the first and second monomers.

15. The method of claim 13, wherein the sequential input of the first and second monomers comprises:
inputting the first monomer at a first position of the reaction chamber; and
inputting the second monomer at a second position, a predetermined distance from the first position downstream with respect to a traveling direction of the resulting polymer.

16. The method of claim 13, wherein:
the sequential input of the first and second monomers comprises:
inputting the first monomer at a first time of the reaction chamber, and
inputting the second monomer at a second time, a predetermined time after the first monomer is input; and
the first monomer is a lactam monomer and the second monomer is a lactone monomer or vice versa.

17. The method of claim 15, wherein the predetermined distance between the first and second position is selected to maximize a ratio of block copolymer produced.

18. The method of claim 16, wherein the predetermined time between the first time and the second time is selected to maximize a ratio of block copolymer produced.

19. A method of preparing a toner composition, the method comprising:
sequentially inputting different monomers into a continuous reaction chamber;
inputting a polymerization initiator into the continuous reaction chamber to polymerize the monomers; and
adding a releasing agent, a colorant, and a charge control agent to the polymer of the first and second monomers.

20. The method of claim 19, wherein the sequential input of the different monomers comprises one of:
inputting a second monomer a predetermined time after a first monomer is input; and
inputting a second monomer a predetermined distance from a position of input of a first monomer with respect to a traveling direction of the resulting polymer,
wherein the predetermined time and the predetermined distance are selected to maximize a ratio of block copolymer produced.
